(19) United States
(12) Patent Application Publication
(10) Pub. No.: US 2005/0100394 A1
(43) Pub. Date: May 12, 2005

(54) Adhesive fastener assembly for removably mounting papers and method

(76) Inventor: George Alfred Arkwright, Alexandria, VA (US)

Correspondence Address: SHLESINGER, ARKWRIGHT & GARVEY LLP, 3000 South Eads Street, Arlington, VA, 22202, US

(21) Appl. No.: 10/685,529

(22) Filed: Oct. 16, 2003

Related U.S. Application Data
(63) Continuation-in-part of application No. 10/237,127, filed on Sep. 9, 2002, now Pat. No. 6,719,475.
Application No. 10/237,127 is a continuation-in-part of application No. 09/494,250, filed on Jan. 31, 2000, now Pat. No. 6,447,196.

(51) Int. Cl. B42F 3/00

(52) U.S. Cl. 402/8

(57) ABSTRACT

A plurality of superposed paper engaging fastening pieces having aligned contact adhesive on one side for engaging a paper sheet and an aligned release surface on the opposite side which is engaged by the contact adhesive on the adjacent fastening piece prior to its engagement with a paper sheet.

### CROSS-REFERENCE TO RELATED APPLICATION

This application is a continuation in part of U.S. patent application Ser. No. 10/237,127, filed Sep. 9, 2002 which was a continuation in part of Ser. No. 09/494,250, filed Jan. 31, 2000, now U.S. Pat. No. 6,447,196, both of which are of the same type of adhesive fastener.

### FIELD OF THE INVENTION

This fastening assembly is a group of identical superposed adhesive fastener pieces, which are fastened and flap mounted at their upper section at the top edge central section of a backing panel. Successive file papers are attached to successive contact adhesive sections on the fastener pieces.

### BACKGROUND OF THE INVENTION

These adhesive fasteners were two-hole punched and placed on a conventional prong fastener, that has previously been mounted on a backing panel. The adhesive fasteners are generally rectangular, paper thin plastic pieces which have a longitudinally extending contact adhesive strip. The paper to be filed is attached to the adhesive fastener contact adhesive which engages the upper surface of the paper to thereby mount it on in the backing panel. Papers are inserted under the lowermost unattached adhesive fastener piece. Additional papers to be mounted on the panel are inserted underneath successively higher adhesive fastener pieces.

Formerly, the lowermost unattached fastener piece was lifted and then the adhesive release (non-stick) covering piece on the contact adhesive strip was removed. The paper to be mounted was then simply inserted in position and the fastening piece was released to permit the contact adhesive to engage the top of the paper sheet.

This method of mounting papers, such as in a file folder, avoids the need to punch holes in the papers, and the opening and closing of the metal prongs. It is a quicker and less cumbersome process than the two-hole punch and prong mounting procedure. Additionally, the contact adhesive, although sufficiently strong to hold the paper in position, also permits the adhesive fastener to be pulled away from engagement with the paper so that an individual paper can be separately removed. Consequently, any paper mounted on the panel can be immediately removed from the file, and subsequently returned at any time, without disturbing any other papers that have been placed in the file. Additionally, the use of an adhesive fastener avoids defacing documents and papers by punching two (2) holes in them to accommodate the metal prongs.

However, use of the adhesive fastener was somewhat cumbersome. The thin, plastic adhesive fastener pieces had to be separated. Then the small release covering over the contact adhesive had to be removed from the contact adhesive, and then disposed of.

Additionally, the need to rely on prong fasteners required a large size adhesive fastener in order to mount it on the metal prongs. Experience had shown there was a need for a significantly smaller adhesive fastener that would also adequately hold a file paper in alignment on the panel, and would adequately secure a file paper. It was also necessary to find a simpler panel mounting arrangements than prongs.

There was a need to provide an adhesive fastener assembly which could rapidly be mounted on a file panel, the cost dependence upon prong fastener and mounting, and nuisance of removing the covering strip over the contact adhesive limited more general usage of the adhesive fasteners.

In summary, there was a need for simplification of the operation of the fastener assembly, ability to quickly mount a packet of adhesive fasteners on a backing panel, and significant cost reduction. The factors had precluded wider adhesive fastener use. This invention addresses those shortcomings.

### SUMMARY OF THE INVENTION

This invention is a major advance from the prior adhesive fastener assembly. The new adhesive fastener assembly of this invention is much simpler to use, as a significantly larger potential market, and is more cost effective.

The new adhesive fastener assembly of this invention is not limited to specialized applications.

The very simple procedure required for mounting the file paper substantially increases the general acceptance of the adhesive fastener assembly for ordinary, day to day filing.

The nuisance of isolating the adhesive fastener to be used, and to reach in and separate and remove the adhesive cover release piece was a significant drawback too general usage. Where convenience was a major factor, the need to remove the release piece covering the contact adhesive, and disposing of it, was a major drawback. This invention removes this impediment. The adhesive fastener to be used is immediately separated and ready to receive the file paper. There is no need to remove a covering release piece from the fastener contact adhesive.

This advance, together with the addition of an integral independent mounting element, substantially widens the potential market. The mounting element provides sufficient stability to allow the size of the adhesive fastener to be reduced to about one-half that of the prong adhesive fastener design. In this respect, there is also a substantial reduction in cost.

Cost reduction is another marketing factor of importance or a market item such the adhesive fastener. In this respect, the smaller size, where the material is a very sizeable percentage of cost, is important.

In this respect also, the adhesive fastener of this invention is specifically designed for mass produced simultaneous assembly by an in line lamination assembly process. Consequently, otherwise substantial labor costs are avoided.

From the standpoint of the retail market, it is possible to offer a product that is very convenient to use, and permits the removal of any one file paper from the file and its later replacement, without disturbing any of the other papers in the file.

Much greater convenience in filing a paper than the ordinary two-hole punch and prong mounting method.

The adhesive fastener assembly of this invention permits a user to merely flip up the fasteners with a fingertip and immediately insert the paper to be filed. The cost for this convenience is now not a major consideration.

### BRIEF DESCRIPTION OF THE DRAWINGS

FIG. 1 is a plan view of the adhesive fastener assembly mounted on the panel of a file folder.

FIG. 2 is an enlarged plan view of the adhesive fastener assembly of FIG. 1.

FIG. 3 is a cross-sectional view along line 3-3 of FIG. 2 showing a side view of the mounted adhesive fastener assembly of FIG. 2.

FIG. 4 is a cross-sectional side view of the mounted adhesive fastener assembly similar to FIG. 3 showing the initial step for inserting a file paper.

FIG. 5 is a side view of the adhesive fastener of the assembly similar to FIGS. 3 and 4, cross-sectional view showing a file paper being inserted.

FIG. 6 is a side view of the top adhesive fastener of FIGS. 1 to 5.

FIG. 7 is a side view of a modification of the adhesive fastener of FIG. 6.

FIG. 8 is a perspective view of the adhesive fastener assembly prior to installation on a mounting panel.

FIG. 9 is a plan view similar to FIG. 2 showing an adhesive fastener assembly with another modification of the adhesive fastener.

### DESCRIPTION OF THE INVENTION

FIG. 1 shows a two panel shelf type file folder 10, having a covering panel 11 and a backing panel 12. The panel 12 has an upper edge 14. A file paper 16 is mounted on the backing panel as shown, in alignment with the backing panel 12. The upper edge 17 of the file paper is only a small distance, about a quarter inch from the upper edge 14 of the panel 12, and extends parallel to it.

The dotted outline 18 shows the adhesive fastener outline which would ordinarily be occupied by the previous adhesive fastener designs which are mounted on conventional metal prongs. The adhesive fastener packet of this invention, generally indicated at 20, is firmly attached to the backing panel 12 at its central section along the upper edge 14. It is half the length of the previous prong mounted adhesive fastener.

The new adhesive fastener packet 20, permits the file paper 16 to be mounted within the confines of the panel without extending below the bottom edge of the adjacent panel 11. The adhesive fastener packet is sufficiently strong to hold the papers firmly in position without permitting any skewing or misalignment.

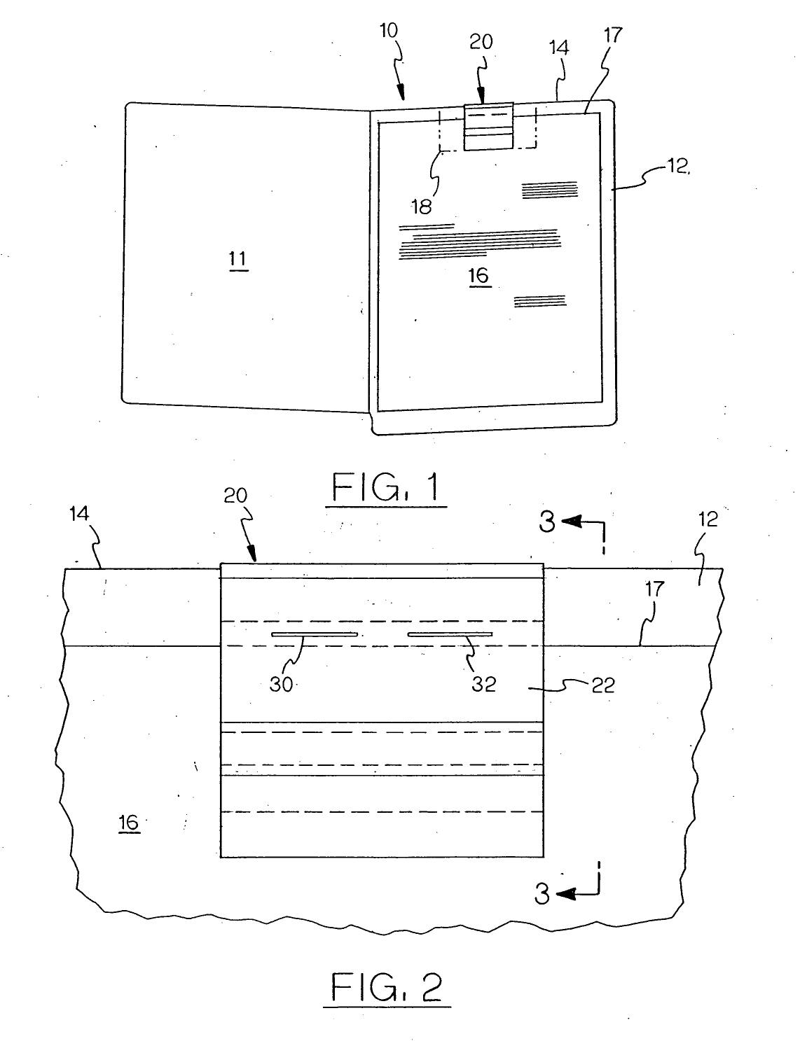

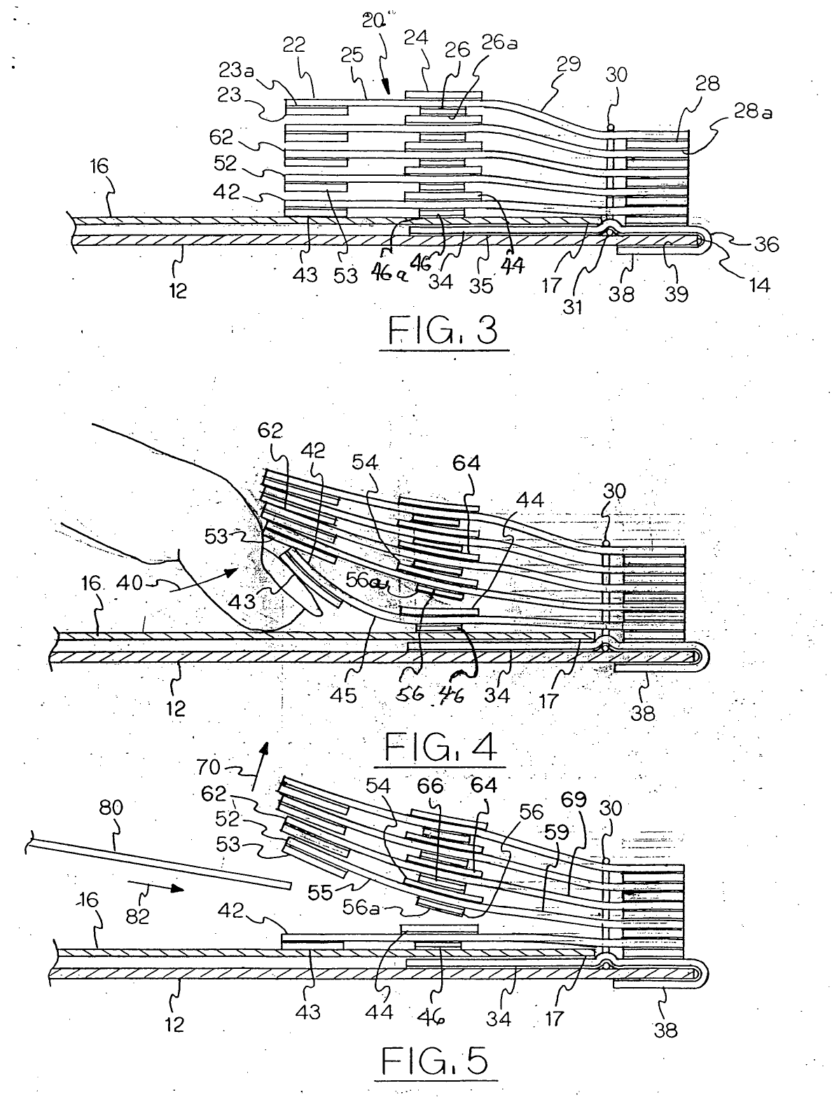

The detailed construction and mounting arrangement of the adhesive fastener packet 20 is shown in FIGS. 2 and 3. The adhesive fasteners are rectangular, paper thin plastic pieces, such as polypropylene. They are of identical construction and are held together in superposed alignment at their top section.

Referring to FIGS. 2 and 3, the uppermost adhesive fastener 22 is identical in construction with the adhesive fastener pieces below it. It has a bottom finger grippable free section having a clear adhesive tape 23 extending across the undersurface of the lower free edge. The top stiffens the section and enables the fingertip of the user to more readily separate and to lift and separate the fastener pieces.

A release strip of tape 24 has a permanent contact adhesive on its lower surface adhered to the upper surface of the adhesive fastener 22. It extends longitudinally across flexible plastic fastener piece 22. The upper surface of the release strip of tape 24 has a release surface, for example, a silicone coating to which contact adhesive will not adhere.

The section 25 between the release tape 24 and the reenforcing strip 23 is about a quarter of an inch wide. It provides a flexible longitudinally extending bending section 25.

A two-sided strip of adhesive tape 26 having a permanent high tack adhesive (about 25 ounces) is adhered to the undersurface of the fastening piece 22 immediately under and in alignment with the release strip 24 on the underside of the tape 26. It has a contact adhesive coating 26a of medium tack adhesive. The medium tack contact adhesive is in the range of approximately 10 to 14 ounce rating.

The adhesive strip 26 provides a long and narrow strip of contact adhesive about one eighth of an inch wide. This strip of contact adhesive 26a provides adequate capacity to prevent the file paper from being pulled out of the file, or from peeling away from the adhesive fastener when the file papers are folded back over the top of the mounting panel 12. However, when the adhesive fastener is pulled upwardly away from the surface perpendicularly to the filed paper to which the fastener is attached, the adhesive readily disengages, permitting the paper to be removed.

When the identical adhesive fastener pieces are assembled and aligned above one another, the contact adhesive layer 26a rests on the corresponding release surface of the adjacent adhesive fastener below it.

FIG. 3 is a side view of the assembly showing the file paper 16 after its installation on the panel 12. The medium tack contact adhesive coating 46a of tape 46 is in engagement with the upper central section of the file paper 16. The release tape strip 44 on adhesive fastener 42 is aligned with the contact adhesive strip 56 of fastener 52 (FIG. 4). The adhesive coating 5a rests on the release surface of the release tape strip 44. The adhesive coating 56a, although directly resting on the release surface of the strip of release tape 44, will not adhere to the release surface. This is true for each of the adhesive fasteners in the assembly. This arrangement makes it possible to eliminate the need for a covering strip on the medium tack adhesive strip of an adhesive fastener. When the fasteners are separated from each other to receive a file paper, the adhesive that is to engage the file paper is also immediately exposed and is ready to engage the surface of the file paper. This arrangement eliminates the need for a separate cover piece for the contact adhesive. In this event, the contact adhesive would then be exposed.

Previously, when the adhesive fastener to be used was bent upwardly to permit insertion of the file paper, it was necessary to remove the release tape strip which covered the contact adhesive coating. The invention recognizes that the release cover piece initially required for the adhesive strip, can be eliminated by aligning a release coating surface on the underlying adhesive fastener, and then it is unnecessary to remove an adhesive release covering before the adhesive fastener can be attached to the paper to be filed.

It was also recognized that for the user, the separation of the lowermost unattached fastener could be simplified. Separation could also be reduced to a simple one finger operation when the condition of the lowermost and attached adhesive fastener was brought into play.

FIG. 4 illustrates the separation action. The adhesive fastener 42 is held down because of its attachment to the previously file sheet 16. All of the adhesive fasteners above it are free to move upward.

FIGS. 4 and 5 illustrate the manner of adding a file sheet. The file sheet 16 is shown connected to the lowermost adhesive fastener 42 after that file paper 16 has been filed. FIGS. 4 and 5 show the sequence of the lift and insert steps respectively in the installation of a file paper. Adhesive file fastening piece 42 and adhesive fastener 52 immediately above it are both of identical construction as adhesive fastener 22, previously described. The corresponding parts of these two adhesive fastener pieces 42 and 52, corresponding to the numbered elements described with reference to adhesive fastener 22. For example, the release tape 24 of adhesive fastener 22 corresponds to the release tape 44 of adhesive fastener 42, and to the release tape 54 of the adhesive fastener 52.

FIG. 5 shows the situation after the adhesive fastener 52 is raised and separated from the adhesive fastener 42. The contact adhesive surface 56a is immediately exposed for contacting the incoming file paper.

This construction avoids the need to reach under the raised adhesive fastener to remove the cover release strip of an engaging contact adhesive surface. The need to remove such a strip before the adhesive fastener could be affixed, was a major nuisance and drawback to the use of the adhesive fastener itself.

It was an additional nuisance to dispose of the removed cover strip itself. The elimination of the need for removal of the cover strip is a major simplification for the user.

Further, the ordinary adhesive fastener itself is a thin flexible plastic, such as polypropylene about the thickness of a sheet of paper, two (2) mils, and a longitudinal length of about one and three quarter inches. Separation of one adhesive fastener from another was not previously quick and immediate. To expedite finger engagement and separation, the free end of the fasteners was thickened by the application of a strip of adhesive to the free, bottom end of the adhesive fasteners as shown at 23, 43 and 53.

The back of the finger is used to press in and up against all of the free ends of the adhesive fasteners, including the lowest and attached adhesive fastener 42, as shown in FIG. 4. This simple single action presses up all of the adhesive fasteners, and lifts the adhesive fastener 52 and its adhesive strip 56 free from the release tape 44 (to which is does not adhere), as illustrated in FIG. 4. Continued upward movement allows the unattached adhesive fasteners above fastener 42 to move further upward. But, fastener 42 is held down because of its attachment to the file paper 16 at contact adhesive strip 46. The free end of adhesive fastener 42 bends at the hinge section 43, and the fingertip brushes up and by it, allowing the free end 43 of adhesive fastener 42 to drop down into engagement with the previously filed paper 16, as shown in FIG. 5. It is then only necessary to insert, with the other hand, the end of the paper 80 under the fastener 52 and into engagement with its contact adhesive 56a.

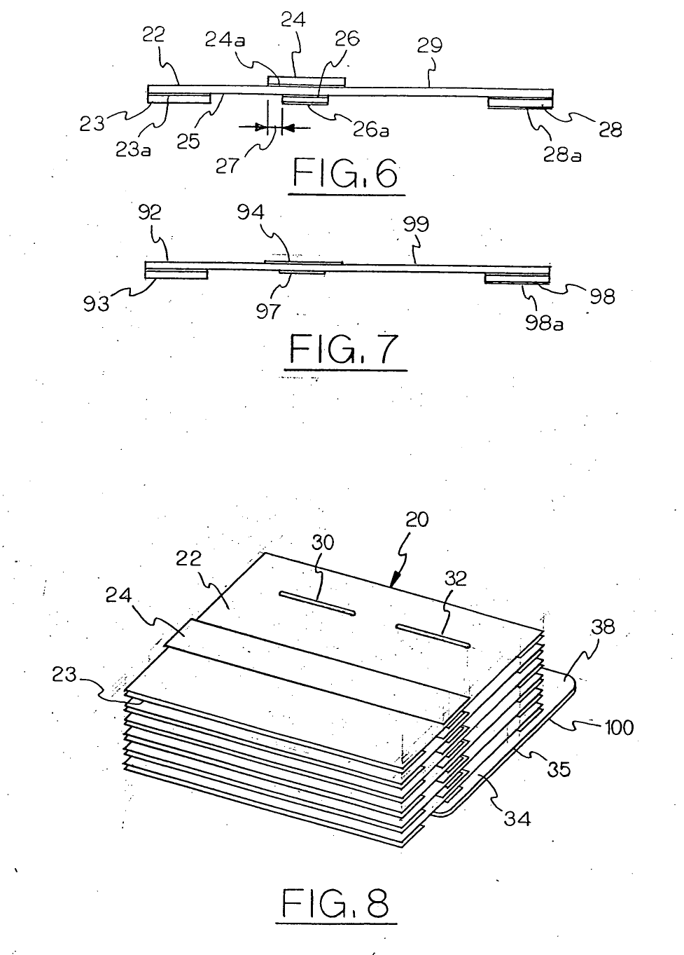

FIG. 6 shows a side view of adhesive fastener 22 previously discussed with respect to FIGS. 1 to 3. Of interest are the release tape strip 24, and the two sided contact adhesive strip 26 of the release tape 24 which has a non-stick release surface 24a. Contact adhesive tape 26 has a contact adhesive layer 26a, which is an acrylic adhesive. The adhesive fastener piece 22 is preferably polypropylene, although polyethylene or similar flexible material can be used. The surface of the adhesive fastener piece 22 are preferably roughened by dyne treatment to enhance adhesion.

As discussed previously, the strip of tape 23 of the free lower end of adhesive fastener 22 gives some additional thickness which makes is easier for the user to engage with the fingertip, since the adhesive fastener is only about 2 mils thick. The strip of binding tape 28 has two layers 28a of high tack adhesive to hold the adhesive fasteners together along their top section, as previously discussed.

The differential dimension 27 is necessary to ensure that misalignment during the course of assembly will not cause any of the adhesive 26a to extend over the surface of the adjacent underlying release non-stick coating of the adhesive fastener along adhesive fastener 22. This is in construction for all of the fasteners previously described with respect to FIGS. 1 to 5.

FIG. 7 illustrates a modification of the adhesive fastener that is considered to be within the scope of the invention. Adhesive fastener 22 does not have a release tape, nor a contact adhesive tape. The adhesive fastener 92 has a release coating 94 of silicone, or a similar release type coating material on the upper surface. A release coating would be applied to the length of polypropylene adhesive fastener material prior to addition of the tape material.

Similarly, a coating layer could also be applied to the length of adhesive fastener material, in terms of an adhesive tape.

The strip of contact material could either be continues or a series of discontinuous dots or blocks.

It has been found that for a slightly less than a two inch length adhesive fastener, a one-eighth inch to one quarter one-quarter inch width is sufficient for file use.

FIG. 8 is a perspective view of the adhesive fastener assembly generally indicated at 20, previously described the label 34 extends across the whole width of the fastener and down to slightly below the contact adhesive tape on the lowermost adhesive fastener. It provides a wide and expensive adhesive holding area for the label, and a good support for the staples 30 and 32 which pass through the label, as previously discussed. The high tack permanent adhesive layer 35 on the undersurface of the label 34 is covered by a removable paper release piece 100. Note that the label section 38 extends above the top edge of the adhesive fasteners toward the upper section 38 of the label 34 is bent over and around the mounting panel as shown in FIGS. 2, 4 and 5. This provides added holding power that will prevent separation of the adhesive 35 from the mounting panel.

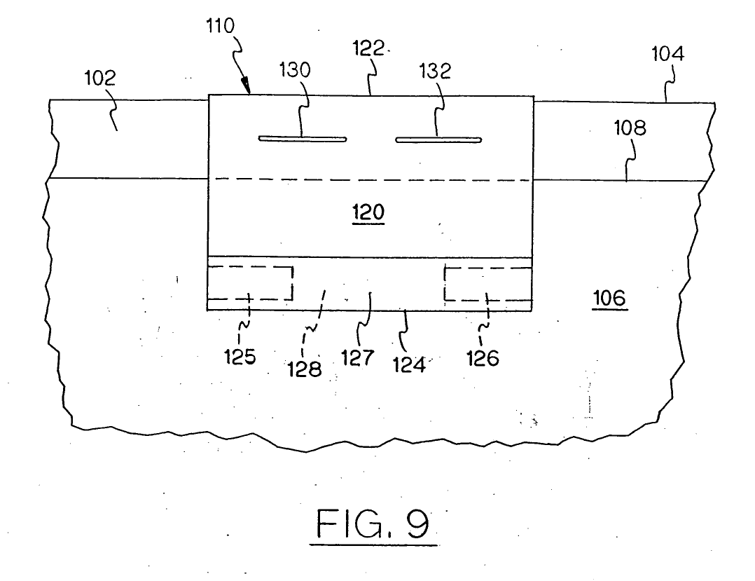

FIG. 9 is a view similar to FIG. 2 showing the mounted adhesive fastener assembly 110 mounted along the upper edge 104 of the mounting panel 102. File paper 106 has an upper edge 108 that is close to (within one quarter inch) and parallel to the mounting panel upper edge 104. The adhesive fastener 120, in this modification, is generally the same in construction as FIGS. 6 and 7, but there is a modification in the adhesive layer, and also the absence of a free bottom finger engaging section. The adhesive fastener 120 which is typical for all of the underlying adhesive fasteners of the assembly have an upper edge 122 and a lower edge 124. The lower surface of the adhesive fastener 120 has two spaced patches of a contact adhesive coating adjacent each side of the adhesive fastener 120 and extending partially along the lower edge of the fastener 120. The upper surface of the adhesive fastener 120 has either a release coating layer, or a strip of release tape. This space between the two patches of adhesive 125 and 126 is sufficiently wide to permit a fingernail to be inserted under the lower edge 124 of fastener 120 and lift up the fastener, freeing the contact layer adhesive of the adhesive fastener 120. The staples 130 and 132 pass through all of the adhesive fasteners as well as the label (not shown) to hold the adhesive fastener assembly together. In this modification, the intermediate double-sided permanent tape (i.e., tape 28) joining the upper edge sections of the fasteners is ommitted. This simple construction is also possible, and is within the scope of the invention.

Although the foregoing description of the invention describes the adhesive fasteners which have a contact adhesive on their undersurface, this invention also contemplates the possibility of applying the contact adhesive to the upper surface of the adhesive fasteners, as well.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. An adhesive fastening assembly for mounting papers on a panel, comprising:
a) plurality of superposed and aligned relatively small, paper thin, and readily bendable flexible adhesive fasteners for a paper mounting panel, which are which are held together along their common longitudinally extending top section to form a fastener packet;
b) a supporting element connected to at least the lowermost adhesive fastening piece along at there top section, which is adapted to engage an edge of the file paper mounting panel to support the adhesive fasteners packet in a flap-like manner;
c) each adhesive fastener having a narrow medium tack releasable contact adhesive section below the adhesive fastener top section to engage the top central edge section of a filed paper; and
d) a non-stick release surface on the surface of each adhesive fastener opposite from and in alignment with the contact adhesive section, and which will contact and cover, only lightly adhere to, and will separate from the contact adhesive on an adjacent adhesive fastener which is connected to a file paper, whereby the contact adhesive will readily separate from the release surface to immediately expose the contact adhesive when an upward force is exerted on these adjacent adhesive fasteners are separated from each other to allow a file paper to be inserted.

2. The adhesive fastening assembly as set forth in claim 1, wherein:
a) the adhesive fastener has a finger engageable section adjacent to and below the contact adhesive to permit the user to more readily separate the fasteners from each other, and to allow insertion of the top edge section of a paper, and its subsequent engagement of the paper with the contact adhesive.

3. The adhesive fastening assembly as set forth in claim 1, wherein:
a) the contact adhesive has an adhesive tack which normally adheres to the file paper to which it is attached to preclude disengagement during file use, but will readily disengage when a small upward force away from the surface of the file paper is applied to the adhesive fastener piece.

4. The adhesive fastening assembly as set forth in claim 3, wherein:
a) the supporting element has a high tack permanent adhesive surface for engaging the mounting panel; and
b) a removable covering piece having a non-stick release surface, covers the permanent adhesive of the supporting element.

5. The adhesive fastening assembly as set forth in either claims 1, or 2, or 3, or 4, wherein:
a) the contact adhesive section has a narrow strip of medium tack contact adhesive extending longitudinally across the surface of the fastening piece and parallel to the top section.

6. The adhesive fastening assembly as set forth in claim 5, wherein:
a) the contact adhesive is an acrylic adhesive having a peel value of from 8 to 16 ounces.

7. The adhesive fastening assembly as set forth in claim 3, wherein:
a) the contact adhesive is disposed on the underside of each of the adhesive fasteners.

8. The adhesive fastening assembly of claim 7, wherein:
a) the adhesive fastener each have a finger engageable section below and parallel to the contact adhesive to permit the user to engage and readily lift the two adjacent attached and unattached fasteners.

9. The adhesive fastening assembly as set forth in claim 3, wherein:
a) the contact adhesive is disposed in an adhesive section which extends longitudinally across the surface of the adhesive fasteners, and parallel to their top section.

10. The adhesive fastening assembly as set forth in claim 9, wherein:
a) the contact adhesive is a continuously extending layer.

11. The adhesive fastening assembly as set forth in claim 9, wherein:
a) a spaced plural contact adhesive configuration is disposed within the adhesive section.

12. The adhesive fastening assembly as set forth in claim 9, wherein:
a) the adhesive section is disposed on the underside of each adhesive fastener; and
b) the contact adhesive is a continuous layer of medium tack contact.

13. The adhesive fastening assembly as set forth in claim 12, wherein:
a) the contact adhesive coating is disposed on the underside of a length of tape adhered to the undersurface of each adhesive.

14. The adhesive fastening assembly as set forth in claim 13, wherein:
a) the length of tape disposed on the underside of the adhesive fastener is less than five-sixteenths inch wide.

15. The adhesive fastening assembly as set forth in claim 3, wherein:
a) the release non-stick surface is disposed on a continuous length of tape which is adhered to the surface of the adhesive fasteners.

16. The adhesive fastening assembly as set forth in claim 3, wherein:
a) the release non-stick surface is a coating which has been directly applied to the surface of the adhesive fastener.

17. The adhesive fastening assembly as set forth in claim 2, wherein:
a) the finger engageable section is the lower longitudinally extending bottom free end section of the adhesive fasteners.

18. The adhesive fastening assembly as set forth in claim 17, wherein:
a) the finger engageable section has a longitudinally extending strip of adhesive tape which thickens the finger engageable section to provide for better finger gripping.

19. The adhesive fastening assembly as set forth in claim 13, wherein:
a) the supporting element is a label having a high tack permanent adhesive surface for engaging the mounting panel.

20. The adhesive fastening assembly as set forth in claim 14, wherein:
a) the adhesive fasteners are rectangular pieces of plastic material approximately between one and a half to two inches in length.

21. The adhesive fastening assembly as set forth in claim 20, wherein:
a) the adhesive fastener piece is polypropylene; and
b) the contact adhesive is an acrylic adhesive.

22. The adhesive fastening assembly as set forth in claim 12, wherein:
a) the adhesive fastener has a finger engageable section adjacent to the contact adhesive to permit the user to more readily separate the fasteners from each other, and to allow insertion of a paper, and is subsequent engagement of the paper with the contact adhesive.

23. The method of mounting file sheets in a file folder, comprising:
a) collecting a rectangular backing panel of which file papers are to be mounted; attaching a plurality of superposed and aligned identical adhesive fastener pieces to an upper edge of the panel, which have a thin layer of contact glue on one surface thereof for engaging a file paper, and having a non-stick release coating in alignment with the adhesive layer and on the opposite surface of the adhesive fastener, so that the adhesive on adjacent fastening pieces is in contact with and covered by the release non-stick coating on an adjacent adhesive fastener; and
b) lifting the lower free edge portion of a fastening sheet to expose the contact adhesive on the surface of one of the adjacent fasteners; and inserting the upper edge of a file sheet between the two separated adhesive fasteners to permit the contact adhesive on one of the adjacent adhesive fasteners to adhere to the paper file sheet.
